(19) United States
(12) Patent Application Publication
(10) Pub. No.: US 2024/0303210 A1
(43) Pub. Date: Sep. 12, 2024

(54) Method, Apparatus, Device and Computer-Readable Medium for Bringing Up a Multi-Purpose Communication Port

(71) Applicant: Intel Corporation, Santa Clara, CA (US)

(72) Inventors: Udaya NATARAJAN, El Dorado Hills, CA (US); Kannappan RAJARAMAN, Bangalore (IN)

(21) Appl. No.: 18/501,078

(22) Filed: Nov. 3, 2023

(51) Int. Cl. G06F 13/38; G06F 11/14; G06F 13/42

(52) U.S. Cl. CPC G06F 13/387; G06F 11/1417; G06F 13/4282

(57) ABSTRACT

Some aspects of the present disclosure relate to an apparatus for bringing up a multi-purpose communication port, the apparatus comprising interface circuitry, machine-readable instructions, and processor circuitry to execute the machine-readable instructions to determine, during a boot phase, a link type of a link to be established via the multi-purpose communication port, and perform, during the boot phase, link training on the multi-purpose communication port according to the link type, wherein, in case the link supports a first higher link rate or a first higher number of lanes, a second lower link rate or second lower number of lanes is used for link training on the multi-purpose communication port.

### BACKGROUND

The Universal Serial Bus (USB) is a commonly used technology that allows computers and other electronic devices to communicate with each other. It was developed in the mid-1990s by a consortium of companies with the main goal to standardize the connection of peripherals to computers. USBs are used to connect a variety of devices, such as keyboards, mice, cameras, printers, flash drives, and external hard drives, among others. USB carries both data and power, allowing devices not only to interact with one another but also to charge or power peripherals from the host device.

USB-C, also known as USB Type-C, is a type of USB connector that was introduced in 2014. Unlike its predecessors (USB A/B, and USB Mini and Micro), the USB-C has a reversible plug orientation and cable direction which means that there's no longer a ‘right way up’. Furthermore, USB-C cables are capable of carrying significantly more power, allowing them to be used to charge larger devices such as laptops. They can also carry data more quickly, with speeds up to many gigabits per second.

USB-C's versatility extends to its use beyond data and power. For example, in the so-called MFD (Multi-Function Device) mode, the USB-C connector can be used to carry both data and a DisplayPort (DP) signal. Alternatively, only data (or only a display port signal) can be carried. To support a wide range of applications, data (including display signals) can be transmitted via the USB-C connector at different link throughput rates, and with different numbers of lanes being used to transmit the data.

### BRIEF DESCRIPTION OF THE FIGURES

Some examples of apparatuses and/or methods will be described in the following by way of example only, and with reference to the accompanying figures, in which:

FIG. 1a shows a flow chart of an example of a method for bringing up a multi-purpose communication port;

FIG. 1b shows a block diagram of a corresponding apparatus or device for bringing up the multi-purpose communication port, and a computer system comprising such an apparatus or device and the multi-purpose communication port;

FIG. 2a shows an example of dual-lane I/O for a host and device;

FIG. 2b shows an example of a single lane USB4 link;

FIG. 2c shows an example of a dual lane bonded USB4 link;

FIG. 3a shows an excerpt of a link state machine according to the USB4 specification;

FIG. 3b shows an excerpt of a modified link state machine;

FIG. 4 shows an overview of proposed changes to a BIOS connection manager;

FIG. 5 shows an example flow of USB3.2 PHY capabilities discovery;

FIG. 6 shows a schematic diagram of a display source and sink setup with four lanes;

FIG. 7 shows a flow of configurations applied by a BIOS or low-level firmware;

FIG. 8 shows a flow chart of port partner exchanges over the power delivery protocol;

FIG. 9 shows a schematic diagram of SoC safe mode detection;

FIG. 10 shows a schematic diagram of a MFD host and device setup; and

FIG. 11 shows an MFD Alt Mode enter sequence.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

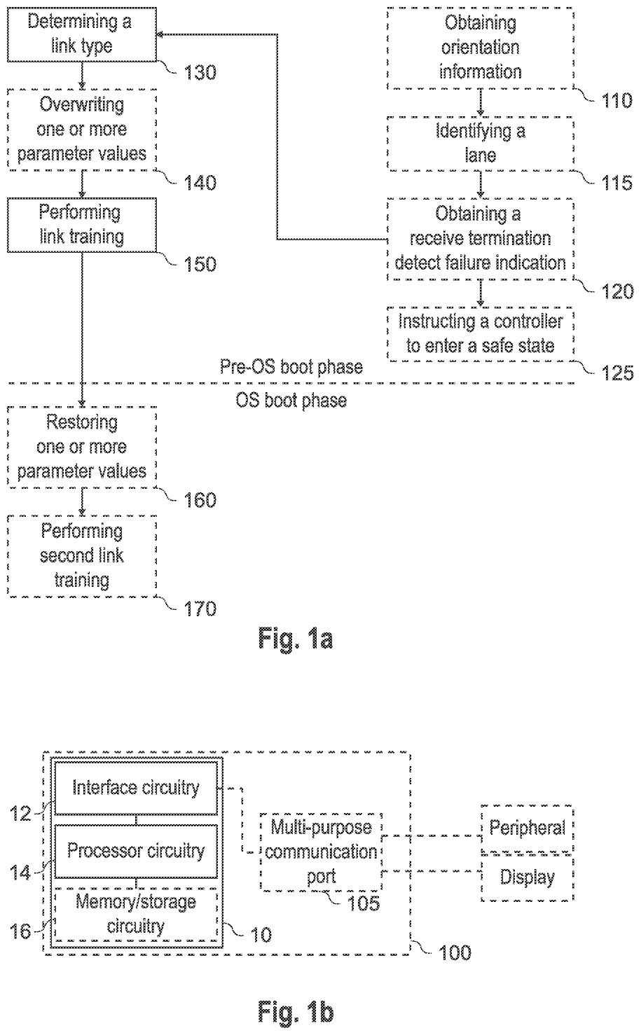

FIG. 1a shows a flow chart of an example of a method for bringing up a multi-purpose communication port, such as an USB-C port. The method comprises determining 130, during a boot phase (e.g., a pre-operating system boot phase), a link type (or connection type) of a link to be established via the multi-purpose communication port. The method comprises performing 150, during the (pre-operating system) boot phase, link training on the multi-purpose communication port according to the link type. In case the link supports a first higher link rate or a first higher number of lanes, a second lower link rate or second lower number of lanes is used for link training on the multi-purpose communication port. As link training on a lower link rate, and without the use of lane bonding, is faster than with a higher link rate and with the use of link bonding, the (pre-operating system) boot phase can be sped up with only minor drawbacks in functionality. During the subsequent operating system boot phase, link training is repeated at higher link rates and/or with the use of lane bonding, to make the full potential of the respective links available to the end user.

FIG. 1b shows a block diagram of a corresponding apparatus 10 or device 10 for bringing up the multi-purpose communication port 105, and a computer system 100 comprising such an apparatus 10 or device 10 and the multi-purpose communication port 105. The apparatus 10 comprises circuitry to provide the functionality of the apparatus 10. For example, the circuitry of the apparatus 10 may be configured to provide the functionality of the apparatus 10. For example, the apparatus 10 of FIG. 1b comprises interface circuitry 12, processor circuitry 14, and optional memory or storage circuitry 16. For example, the processor circuitry 14 may be coupled with the interface circuitry 12, and with the memory or storage circuitry 16. For example, the processor circuitry 14 may provide the functionality of the apparatus, in conjunction with the interface circuitry 12 (for exchanging information, e.g., with other components inside or outside the computer system 100 comprising the apparatus 10 or device 10, such as components associated with the multi-purpose communication port, such as a (USB3.2, USB4 or Thunderbolt 3/4) host controller, a DisplayPort source, a Power Delivery component etc.), the memory or storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1a comprises means for processing 14, which may correspond to or be implemented by the processor circuitry 14, means for communicating 12, which may correspond to or be implemented by the interface circuitry 12, (optional) means for storing information 16, which may correspond to or be implemented by the memory or storage circuitry 16. In general, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The apparatus 10 or device 10 may comprise the machine-readable instructions, e.g., within the memory or storage circuitry 16, a storage circuitry (not shown), or means for storing information 16.

The processor circuitry 14 or means for processing 14 is to perform the method of FIG. 1a. In particular, the processor circuitry 14 or means for processing 14 is to determine, during the (pre-operating system) boot phase, the link type of the link to be established via the multi-purpose communication port. The processor circuitry 14 or means for processing 14 is to perform, during the (pre-operating system) boot phase, link training on the multi-purpose communication port according to the link type. In case the link supports a first higher link rate or a first higher number of lanes, a second lower link rate or second lower number of lanes is used for link training on the multi-purpose communication port.

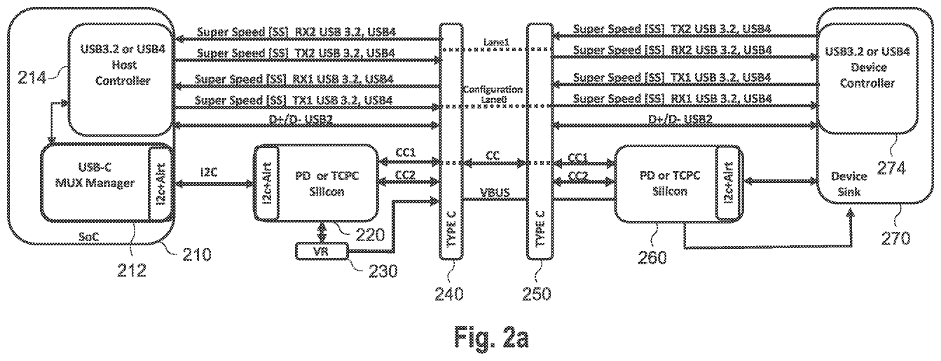

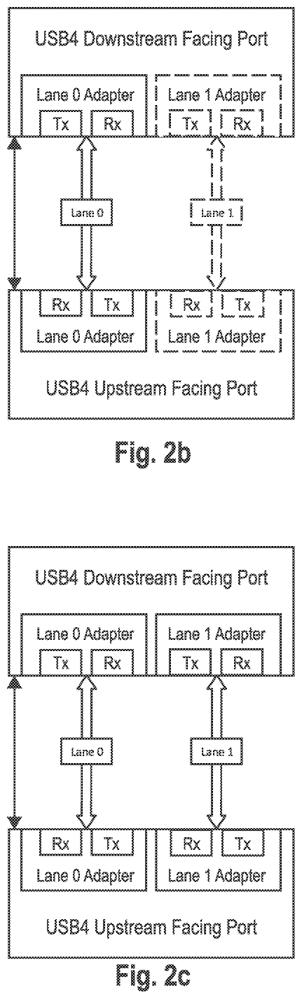

Various examples of the present disclosure relate to a concept for reducing the time required for the pre-operating system (OS) boot process, and thus the overall boot process. This concept is based on simplifying the link training during the (pre-OS) boot phase, by using a less than maximal link rate and, if possible, a less than maximal number of lanes during the training during the (pre-OS) boot phase. In other words, during the (pre-operating system) boot/training phase, the link training may be performed with a minimal number of lanes (e.g., one lane in case of an USB4, USB3.2 or DP2.1 connection, two lanes in case of an MFD connection) and/or with a minimal link rate supported by the respective link. In addition, some other optimizations may be applied to further reduce the boot time. Details of both types of optimizations will be shown in the following with reference to FIGS. 2a to 11.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processor circuitry 14 or means for processing 14 may be implemented using one or more processing units, one or more processing devices, any means for processing, such as a processor, a computer or a programmable hardware component being operable with accordingly adapted software. In other words, the described function of the processor circuitry 14 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 16 or means for storing information 16 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the method of FIG. 1a and of the apparatus 10, device 10, computer system 100 and multi-purpose communication port 105 of FIG. 1b are mentioned in connection with the proposed concept or one or more examples described above or below (e.g., FIGS. 2a to 11). The method of FIG. 1a and the apparatus 10, device 10, computer system 100 and multi-purpose communication port 105 of FIG. 1b may comprise one or more additional optional features corresponding to one or more aspects of the proposed concept, or one or more examples described above or below.

Various examples relate to link optimization methods for (USB) Type C protocols to reduce system boot time and power.

Many modern PCs (Personal Computers) support one or more (USB) Type C ports. Many Type C ports enable USB4 (or Thunderbolt 4), DP 2.1 (Display Port), USB3.2 and multi-function I/O (Input/Output) modes. In other words, the link type being referred to in the method of FIG. 1a and the apparatus 10/device 10 of FIG. 1b may be a data link (e.g., USB4, Thunderbolt 4 or USB3.2), a graphics link (e.g., DP 2.1), or multi-functional link (MFD). In all the modes except multi-function device mode (MFD) the ports can operate either in single or dual lane. FIGS. 2a to 2c shows single and dual lane operation for USB2.2x2 & USB4 specification, with FIG. 2a showing an USB3.2 or USB4 dual-lane link, FIG. 2b showing a single lane USB4 link and FIG. 2c showing a dual lane bonded USB4 link.

The USB3.2x2 and USB4 dual lane I/O for a host and device is shown in FIG. 2a. FIG. 2a shows a host with an SoC 210, a Power Delivery or TCPC (Type C Port Controller) silicon 220 that is coupled with the SoC via an I2C connection and an alert (alrt) signal, a voltage regulator 230 and the Type C connector 240. The SoC 210 comprises an USB-C MUX (multiplexing) manager 212 and an USB3.2 or USB4 host controller 214. The host controller 214 is coupled with two bi-directional lanes 0 and 1 (RX1, TX1, RX2, TX2) in super-speed configuration (for USB3.2 or USB4), of which lane 0 is the configuration lane, and to D+/D− for USB2 communication. The PD or TCPC silicon 220 is coupled with Communication Channels CC1 and CC2, and the voltage regulator 230 is coupled with VBUS of the USB Type C connector 240. The peripheral device similarly includes a Type C connector 250, a PD or TCPC silicon 260, and a device sing controller 270 with an USB3.2 or USB4 host controller 274.

USB4 links can be established on a single lane or dual lane. FIGS. 2b and 2c describes single and dual lane operation as defined in USB4 specification. In the example of FIG. 2b, Lane 1 is disabled and the Lane 0 adapter of the USB4 Upstream Facing Port (UFP) is the upstream adapter. In the example of FIG. 2c, lane 0 and lane 1 are bonded. When operating in a dual lane link the two lanes 0, 1 are bonded together to form a unified data channel. Bonded lanes double the data rate but comes at a cost of higher power and latency to enter and exit the operational ‘CL0’ link state. In bonded mode link states entry and exit will consume power and increase latency for enumeration.

The concept is the same for USB3.2x2 (dual lane USB3.2), which uses two lanes as also shown in FIG. 2a. Although initial receiver termination detection and low frequency signaling is done on a single lane, further training of high-speed link bring up with ordered sets is done on both lanes consuming more power and latency to bring the link up. The conditions are similar for the DP 2.1 protocol where the 2 Type C bi-directional lanes are converted to 4 unidirectional lanes. DP 2.1 performs training for 4 lanes at the highest speed and falls to 2, 1 lane or lower speeds subsequently if training fails. Achieving a link at high data rates with all 4 lanes consumes more power and time to train the links.

The MFD mode requires both the lanes to operate. For example, one bi-directional lane may be used for USB3.2x1 and the other 2 unidirectional lanes may be used for DP 2.1 for simultaneous multi-protocol functionality. Hence both the lanes are required for MFD.

In USB4 or USB3.2x2, the maximum double data rate is not always required. Similarly, high-resolution Display link is not always required in a system application. For instance, when a computer system is booting in the pre-OS-BIOS (Basic Input/Output System, a system firmware) phase with devices attached, such as a USB4 display panel or USB4/USB3.2x2 storage or a high-resolution display panel, in the transitory booting BIOS phase, a minimal display of sign of life and basic low data rate functionality is all that is required.

Achieving faster boot time with less power consumption while initializing to the main operating system, such as Windows or Chrome OS, is a key user experience and benchmark metric. Some systems bring up the link in USB4/USB3.2x2 Dual link bonded mode or x4 DP2.1 link width at highest data rates in the pre-OS-BIOS or pre-OS boot sequence when a device is attached. In most cases, the full features are not required in the boot phase. Also, BIOS or firmware (FW) may have to manage lane bonding failure by reverting to single lane operation, or, in the case of DP2.1, may have to train at a lower lane width and speed. If the links are brought up at maximal link rates and with link bonding, this takes time since the BIOS firmware algorithm has to process the link state machine failures. This results in a slower boot time and a higher power consumption. The BIOS or FW has to manage failsafe single lane fall back mechanism, thus adding complexity in the software implementation. In the following, two proposals are presented to optimize the bring-up of a multi-purpose communication port, such as the USB Type-C port. Proposal 1 describes a method to improve or optimize Type C protocol link to single lane operation.

Another factor contributing enumeration time and more power consumption during boot phase and in the OS is due to the PD (Power delivery) controller protocol sequence. The PD controller (e.g., PD controller 220 in FIG. 2a) is a platform component communicating with the device port partner. The PD controller may cause seconds of latency in enumeration of Type C Alt (alternative) Modes (e.g., USB4, Thunderbolt 4, DP 2.1, MFD) modes. This is because the SoC waits for the PD to trigger Alt Mode commands after the PD has completed power delivery and other mode discovery with the respective port partner. Without breaking the protocol, a second proposal (Proposal 2) uses the SoC (System on Chip) Super Speed (SS) USB Rx.detect (Receive detect) to get ready for the Alt Mode so when the PD triggers the Alt Mode, the SoC is ready to enter the mode. The safe state mode in which the PD controller informs the SoC can be eliminated from the sequence, thus reducing enumeration time latency and power consumption both in the pre-boot and post-boot OS phase.

Various examples of the present disclosure propose multiple methods for the USB4, DP 2.1 and USB3.2 protocols to reduce SoC boot time and boot power consumption by operating at lower link rate and width. Since there are no power management features during system boot, reducing boot power consumption also helps to boot a system with low battery threshold capacity. Furthermore, a faster and less power consuming Alt Mode connect sequence is proposed which helps boot time latency as well as enumeration in the OS. The MFD mode may use the proposed method 2 for a faster configuration mode to reduce the MFD enumeration time and power. The same method may also support USB4, DP2.1 in both pre-OS and OS.

When the SoC system is booted with a USB4 device, a first method (Proposal 1) is proposed to enumerate the device with link in single lane configuration, preferably at the lower Generation 2 speed, limiting the link to a 10 Gbps link throughput rate, without attempting for dual lane (i.e., bonding) or two single lanes of operations at 20 Gbps link rate. In other words, in case the link is a data link according to the Universal Serial Bus 4 protocol, link training may be performed with a single lane at 10 Gbps link rate. Similarly, when booting with the USB3.2 device, the first method (Proposal 1) is proposed to boot with a single lane at the lowest Generation 1 5 Gbps rate instead of the Generation 2 10 Gbps rate or with two lanes at aggregate 20 Gbps. In other words, in case the link is a data link according to the Universal Serial Bus 3.2 protocol, link training may be performed with a single lane at 5 Gbps link rate. In the DP 2.1 application, the first method (Proposal 1) is proposed to scale down to the lowest I/O lane width with a link rate that can be supported by a sink device or panel. In other words, in case the link is a graphics link, link training may be performed with a minimal lane width and/or minimal link rate supported by a display connected to the multi-purpose communication port. Proposal 1 may allow the system to show an early sign of life while booting and reduce the BIOS FW complexity from dual lane/fail safe implementation. Boot time and power consumption may also be reduced, which is an added benefit of this proposal. Proposal 1 thus proposes to reduce the number of lanes and link speed in the boot phase.

Many implementations of MFD enumeration processes go through many interruptions on the USB lane. In case an MFD device is connected, a connect configuration Method 2 (Proposal 1) is proposed to quickly bring up the USB 3.2x1 link without any interruption with concurrent display x1 or x2 width (of maximal x4 width in case two bidirectional lanes are used in unidirectional configuration) at the lowest resolution link rate supported by the device. In other words, in case the link is a multi-functional link comprising a data link and a graphics link, link training may be performed with a respective minimal link rate supported by the protocol used for the data link and with a minimal link rate supported by a display connected to the graphics link. The same method is proposed for USB4, Thunderbolt 4, DP2.1 and future Alt Modes, which helps both in the pre-OS and OS phase. Optimizations with respect to speeding up the MFT enumeration process are also referred to as connect configuration proposal 2.

Both proposal 1 (the lane-data speed reduction in the boot phase) and proposal 2 (the connect configuration method) may provide one or more of the following advantages. They may reduce cold boot time and deep sleep power management state exit time by bringing up the link faster to show an early sign of life in boot phase. Moreover, the SoC system boot phase demands a high-power burst. The two proposals improve power efficiency, by reducing the battery current burst demand contributed by the SoC Host and peripheral device to the overall power envelope. Additionally, the boot time performance and power reduction are directly proportional to the number of ports in a system that are connected to devices. Software overhead can be reduced by avoiding complex high data rate multi lane link bring-up operations. Associated failure and fallback training can be avoided at the boot phase. The proposals may also provide fast enumeration in the boot (Pre-OS) boot phase and in the OS. The concept is applicable to all OS such as Windows OS, Chrome, Linux, or iOS.

In the following, the lane and speed reduction proposal for the boot phase (Proposal 1) is discussed.

First, an example for handling Type-C USB4 devices during the boot phase is given. Some aspects of this proposal may likewise be applied to other device types. The USB4 Connection manager (CM) driver configures, enumerates, and manages an USB4 domain. The CM is residing as a native driver in the operating system that controls the USB4 host router. The native driver has the capability to configure single or dual lane bonded mode at link up and enumeration.

Like the native OS CM driver, its counterpart in the pre-OS phase is implemented by the BIOS/Firmware. In the pre-OS boot phase, the BIOS/Firmware CM brings up the dual lane bonded link. Thus, operations performed during the pre-operating system boot phase may be performed by a system firmware (e.g., BIOS) of the computer system comprising the multi-purpose communication port (i.e., the USB-C port). Bringing each lane to active CL0 state takes around 1 second. Bonding consumes another 100 msec. The bonding helps double the data rate, delivering a maximum of 20 or 40 Gbps for Generation 3 according to the USB4 version 1 specification, and 80 Gbps according to the USB4 version 2 specification, respectively. Doubling the data rate also increases power consumption. The data throughput is necessary for the many user applications when the system has booted to OS. However, it usually is not required in the pre-OS booting phase, as there are no applications that require such bandwidth in this transitory phase.

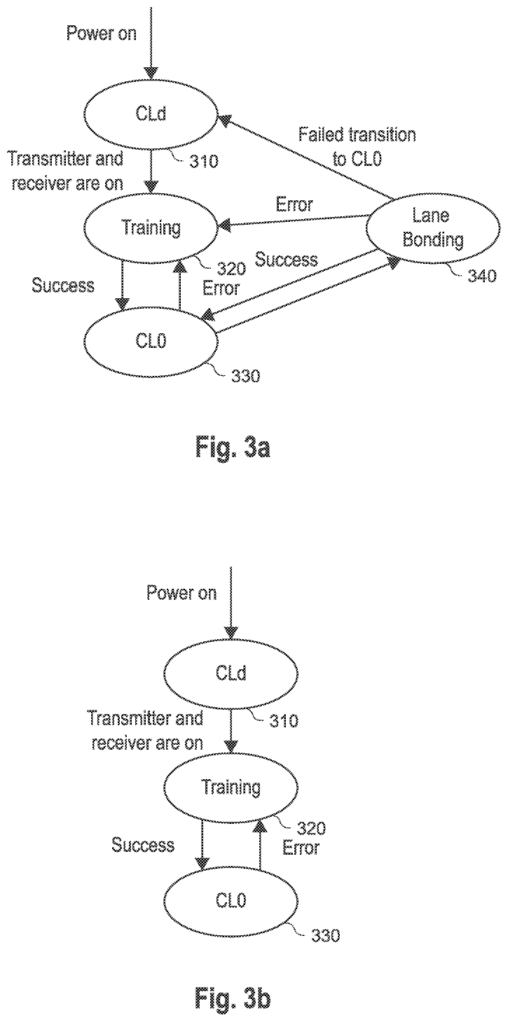

An excerpt of the link state machine of the USB4 specification is shown in FIG. 3a. FIG. 3a shows an excerpt of the link state machine according to the USB4 specification. At power on, the state machine transitions to the CLd state 310. When transmitter and receiver are enabled, the state machine transitions to the training state 320. When training is successfully completed, the state machine transitions to the CL0 state 330. In case of lane bonding, the state machine transitions to the lane bonding state 340 and returns to the CL0 state if lane bonding is successful. In case of errors, the state machine transitions back from the CL0 state or the lane bonding state 340 to the training state 320. If the transition to CL0 fails after lane bonding, the state machine returns to the CLd state 310.

Lane bonding state training is entered if the “Lane Bonding bit” in the lane adapter configuration capability is set. This value is updated by the CM on any one of the lane adapters. Reception of 2 consecutive TS1, TS2 ordered sets will also allow the entry to Lane bonding. Furthermore, the same process is exhibited when exiting low power CL1, CL2 states (not shown in the excerpts of FIGS. 3a and 3b).

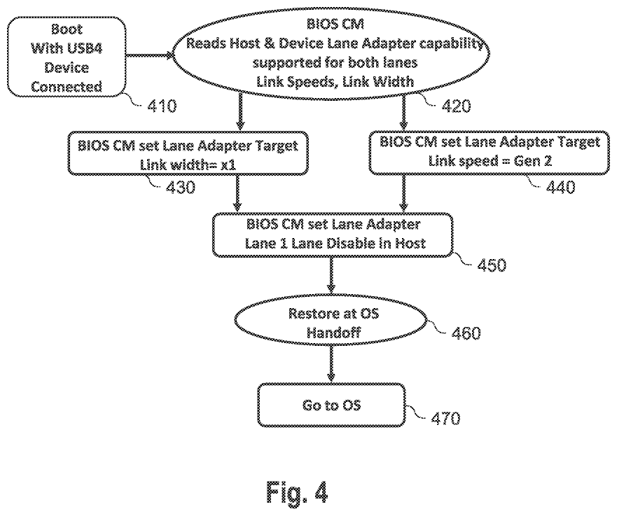

In proposal 1, only a single lane may be enabled (in USB4 mode). Thus, once the link training is successful on Lane 0, the pre-OS FW will not attempt the lane bonding process. This may change the USB4 link state machine as shown in FIG. 3b. FIG. 3b shows an excerpt of a modified link state machine without lane bonding. To make the modification, the BIOS CM driver may be changed. The changes and sequences are listed in FIG. 4.

FIG. 4 shows an overview of changes to the BIOS connection manager. When the computer system boots with an USB4 device connected 410, at 420 the BIOS CM reads, for both lanes and both the host and device, the adapter capabilities with respect to link speed and link width. At 430, the BIOS CM sets the lane adapter target link width to x1 (single lane). At 440, the BIOS CM sets the lane adapter target link speed to Generation 2 (10 Gbps). At 450, the BIOS CM sets the Lane 1 lane disabled bit in the host. In effect, the host and device Lane adapter capability registers are read and modified to meet the goals of the proposal. Link speed is reduced to conserve battery power. The link is reduced to a single lane even if either partner supports dual lane. For example, with respect to the method of FIG. 1a, the method may comprise, during the (pre-operating system) boot phase, in case the link supports a first higher link rate or a first higher number of lanes, overwriting 140 one or more parameter values specifying the link rate and/or number of lanes of the communication link prior to performing the link training at the lower rate and lower number of lanes. The original values are restored 460 at OS handoff, before yielding control to the OS 470. In other words, the values are restored at OS handoff. In other words, with respect to the method of FIG. 1a, the one or more parameter values are automatically (or by the firmware) restored 160 in an operating system boot phase after having performed the link functions during the (pre-operating system) boot phase. Subsequently, during the OS boot phase, the method of FIG. 1a may further comprise performing 170, second link training. During the OS boot phase, the faster link rates and/or higher number of lanes may be used. In other words, in case the link supports the first higher link rate or the first higher number of lanes, the first higher link rate or the first higher number of lanes may be used for link training on the multi-purpose communication port during the operating system boot phase.

The lane bonding target can be achieved by setting the lane number bits [55:48] to Lane 0 [0x0] on the TS1 and TS2 ordered set along with lane bonding target as dual single lane [0x0] in bits [56:58]. The description of TS1 and TS2 can be found in the USB4 specification, e.g., section 4.2.1.3.4.2 of version 2 of the USB4 specification.

Along with the above changes, the BIOS Connection manager may set the lane adapter registers in the specification as specified below. For example, LANE_ADP_CS_1.TARGET_LINK_SPEED may be set to 0x1000, which may limit the link to Generation 2 operating speed. LANE_ADP_CS_1.TARGET_LINK_WIDTH may be set to 0x01, which may limit the link to operate as two single lane links. LANE_ADP_CS_1.LANE BONDING may be set to 0x0 (Default), which may disallow the link for Lane Bonding.

When a USB4 Display panel is detected by the BIOS connection manager, the DP main link training can operate with a minimal supported resolution by the panel. This can be achieved by setting up the Aux (auxiliary) tunneled packet types of configurations as defined in the DP2.1 proposal following below. For example, SET_CONFIG.LANE_COUNT may be set to 2, and SET_CONFIG.LINK_RATE may be set to 1 (1.6 or 2.7 GHZ). Lane count and link status will be updated in the USB4 DPCD registers. This allows to allocate the bandwidth required for the DP x2 tunnel operation, which is well within the USB4 Gen2 single lane bandwidth of 10 Gbps. The same rule can be applied in DP Alternate mode discussed with respect to DP 2.1.

While transitioning from the pre-OS phase (i.e., the firmware/BIOS phase) to the OS, the OS relinquishes the previous configuration and reconfigures the USB4 link to operate in the full operational mode.

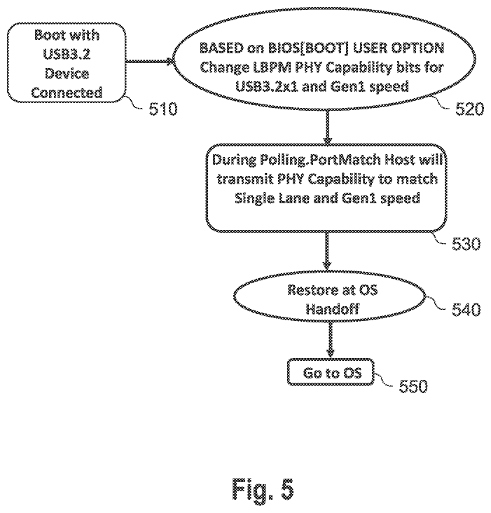

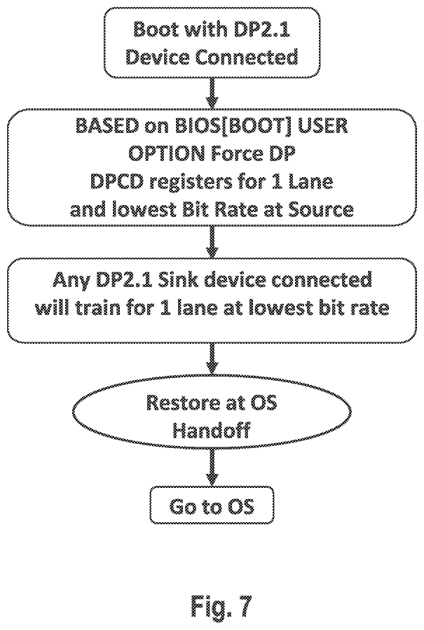

Next, an example for handling Type-C USB3.2 devices during the boot phase is given. Unlike in the USB4 protocol, USB3.2 link management is embedded in the low-level firmware, such as the BIOS and a corresponding link state machine. The USB3.2 protocol conveys the port speed and dual-lane capability during the polling LTSSM (link training status state machine) state using low speed LBPM (low-frequency periodic signaling based pulse width modulation). The polling sub state machine between a host and device is shown in the USB 3.2 specification (e.g., FIG. 7-21 of USB 3.2 Revision 1.1), with details on the Polling.PortMatch state being shown in the USB 3.2 specification as well (e.g., section 7.5.4.5 of USB 3.2 Revision 1.1). According to the specification, four modes are possible: 5 Gbps or 10 Gbps, in single-lane or dual-lane (i.e., lane bonding) configuration. Section 7.5.4.5 of the USB 3.2 Revision 1.1 shows the PHY (Physical Layer) capability LBPM information that is exchanged between a host and device ports. During the Polling.PortMatch state (e.g., shown in FIG. 7-21 of USB 3.2 Revision 1.1), the PHY capability packets are exchanged. In proposal 1, the PHY LBPM bits may be configured to Generation 1 speed (5 Gbps) with a single lane. The BIOS or other low-level firmware can program these bits while bringing the USB port out of reset. Thus, any negotiation with a device may be restricted to the single lane Gen1 speed helping boot time and power reduction. The system sequence is shown in FIG. 5.

FIG. 5 shows an example flow of USB3.2 PHY capabilities discovery. At 510, the computer system boots with an USB3.2 device connected. At 520, the LBPS PHY capability bits are changed to USB3.2x1 and Generation 1 link speed by the BIOS or other low-level firmware. At 530, during Polling.PortMatch, the host may transmit the PHY capability as matching a single lane and Generation 1 speed. At 540, the actually supported values are restored. At 550, control is yielded to the OS.

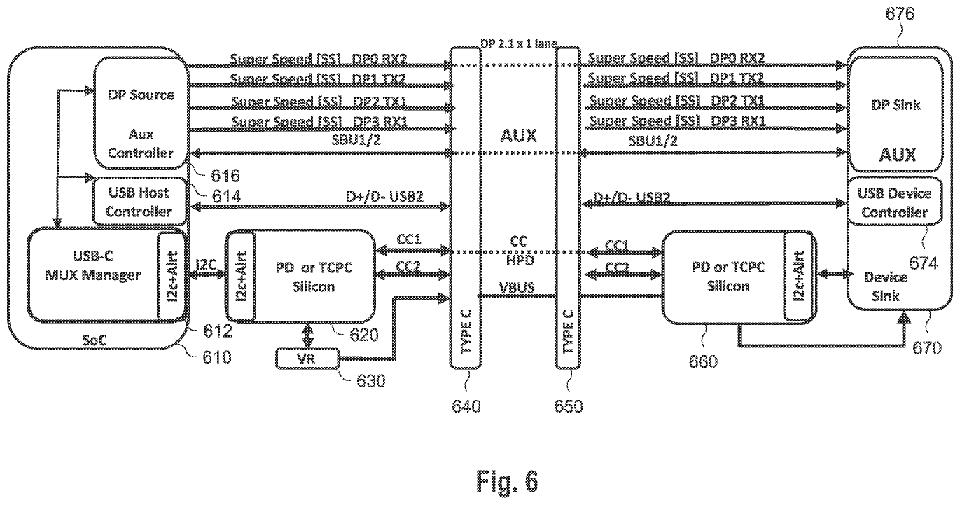

Next, an example for handling Type-C DP 2.1 devices during the boot phase is given. FIGS. 6 and 7 show DP Link bring up with reduced speed and I/O width. FIG. 6 shows a schematic diagram of a display source and sink setup with four lanes. Similar to the setup shown in FIG. 2, a host with an SoC 610 (with an USB-C MUX manager 612, USB host controller 614 (for USB2) and DP source 616), PD or TCPC silicon 620, voltage regulator 630 and Type-C port 640 is shown, and a device with Type-C port 650, PD or TCPC silicon 660 and device sink controller 670 (with USB Device Controller and DP Sink) is shown. When a DP2.1 source-sink is connected, the source (i.e., the host) reads the display device (i.e., the sink) DPCD (display port configuration data) registers via auxiliary transmission lines (SBU1/2). The sink DPCD registers 0x0001, 0x0002[4:0] & 0x0006[1:0] represent the maximum data rate, lane width capability and DP2.1 speed at 128b132b coding. The source then updates these values in DPCD to 0x0100, 0x0101[4:0] & 0x0108[1:0] for the training to match sink capabilities.

FIG. 7 shows a flow of the configurations applied by the BIOS or low-level firmware. When the host boots with a DP 2.1 device connected, the DP DPCD registers are forced to a single lane and the lowest bit rate supported by the source by the BIOS user option. Any DP 2.1 sink device connected will subsequently train for a single lane at the lowest bit rate. The DP DPCD registers may be restored at OS handoff, when the control is yielded to the OS.

The proposal expands on the DP2.1 spec for embedded applications where training is performed based on pre-calibrated parameters. The proposal applies the concept to box-to-box applications for training speed and link width only. Uniquely, the DPCD registers 0x0100, 0x0101[4:0] & 0x0108[1:0] for the source may be forced to lowest speed and single link width (while still matching the (minimal) sink capabilities) to speed up the DP2.1 link up and enumeration and reduce power.

In the following, an example is shown with respect to proposal 2, i.e., the connect safe state configuration improvement or optimization for the boot and OS phase.

The Type C PD controller protocol is triggered at the when a device or port partner is first attached. Immediately when the device or port partner is connected, an implicit power contract is started to power the sink to bring up the USB3.2 I/O functionality. Next the PD sends a USB connect command to the SoC host to switch to USB mode so that SoC can configure the multiplexer to USB3.2 mode and enable the receive Rx.term and start Rx.Detect. If the connected port partner is not a USB3.2 device and is a DP2.1, USB4 or MFD in a flipped orientation, then USB3.2 enumeration will fail within 100 ms of starting an Rx. Detect as per the specification. Therefore, at a very early stage the SoC is aware that an USB3.2 device is not connected and that hence the SoC firmware or state machine can take a decision to be in a safe mode.

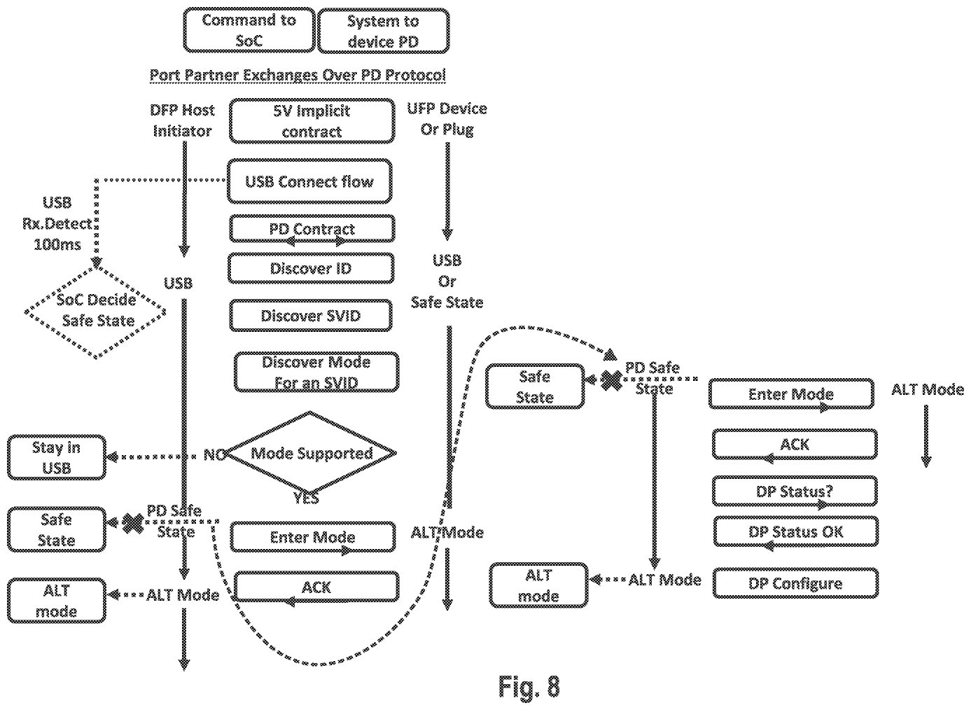

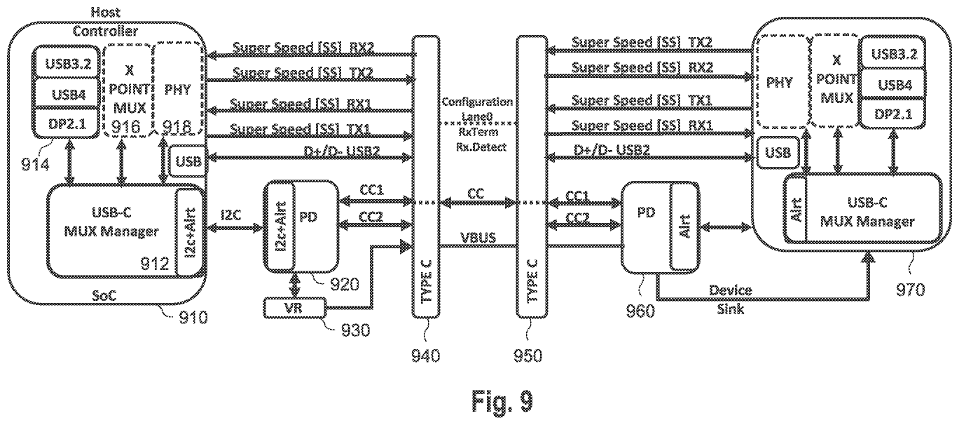

FIGS. 8 and 9 illustrate the safe state improvement or optimization. FIG. 8 shows a flow chart of port partner exchanges over the PD protocol, illustrating the PD safe mode trigger to SoC (for DP 2.1 safe mode trigger), and FIG. 9 shows a schematic diagram of the SoC safe mode detection. As shown on the left in FIG. 8, at a very early stage (at the USB connect flow), after the 100 ms timeout of the Rx. Detect, the SoC can decide to enter the same state. Similar to the setup shown in FIGS. 2 and 6, in FIG. 9, a host with an SoC 910 (with an USB-C MUX manager 912. USB host controller 914 (for USB3.2, USB4, DP2.1), an X-Point multiplexer 916, and an USB2 controller), PD silicon 920, voltage regulator 930 and Type-C port 940 is shown, and a device with Type-C port 950, PD silicon 960 and controller 970 (with an USB-C MUX manager, USB host controller (for USB3.2, USB4, DP2.1), X-Point multiplexer 916, and an USB2 controller) is shown.

In proposal 2, the SoC will not wait for the PD to provide the safe state command much later in the PD protocol, which may lead to a 1-2 second delay. The PD providing the safe state command is illustrated by the curved dotted line in FIG. 8. Proposal 2 is based on a USB3.2 Rx.Detect failure, which is used as trigger by the SoC to disconnect the USB3.2 controller from the Mux and remove receive termination, thus entering safe state. Thus, with respect to the method of FIG. 1a, the method may comprise, in case the multi-purpose communication port supports communication according to a first protocol (e.g., USB3.2 or a first lower USB protocol)) and according to a second protocol (e.g., DisplayPort or a second higher USB protocol, such as USB4 or Thunderbolt 4). A first controller (of host controllers 914) may be used for communicating according to the first protocol and a second controller (of host controllers 914) may be used to communicate according to the second protocol. The method of FIG. 1a may comprise obtaining 120, during the (pre-operating system) boot phase, a receive termination detect failure indication (e.g., USB3.2 Rx.Detect failure) from the first controller and instructing 125 the first controller to enter a safe state based on the receive termination detect failure indication obtained from the first controller.

FIG. 9 shows the SoC multiplexer 916 and the multiplexing manager 912. In the second proposal, the safe state command from PD 920 will be ignored. In other words, the first controller may be instructed to enter the safe state without waiting for a trigger for entering the safe state being provided by a power delivery controller associated with the multi-purpose communication port. When the PD gives the Alt Mode command (e.g., DP2.1 or USB4), then the SoC multiplexer 916 can configure the respective controllers to the PHY. Thus, the SoC 910 does not have to wait for the PD controller safe state command to take actions to disconnect the USB3.2 controller and thereby remove Rx termination. The PD command may be ignored as it is limited by the high-latency PD protocol and long duration power contract. The SoC 910 may configure the safe state based on the proposal of Rx. Detect status ahead of time and wait for the Alt Mode command from the PD. This may help the system to switch to a new mode faster, reliably.

In case of a Type-C MFD device, DP2.1 and USB4 (or Thunderbolt 4) Alt modes may apply the SoC connect safe state proposal both during boot or pre-OS (i.e., the pre-OS boot phase) and in the OS to reduce the enumeration latency.

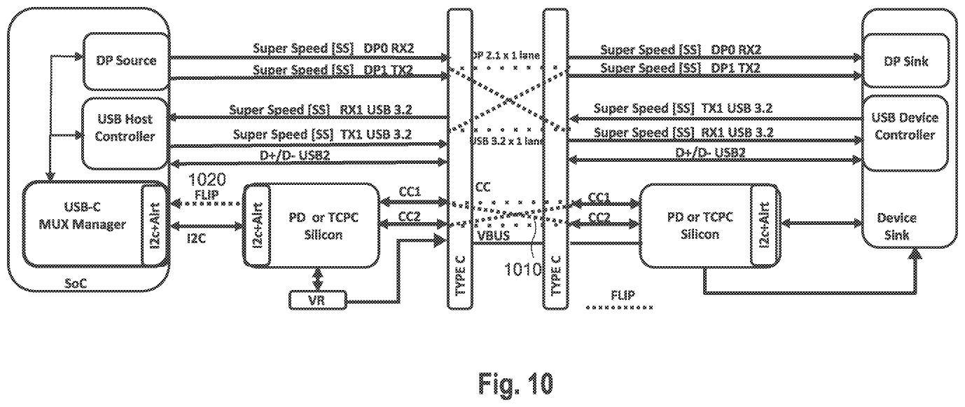

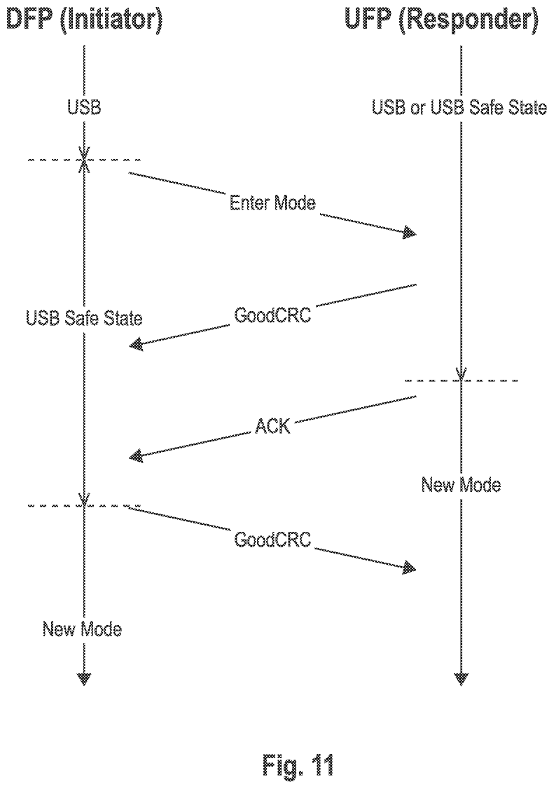

Moreover, MFD protocol devices use all the lanes as shown in FIG. 10. Thus, optimization cannot be done based on lane reduction. The data rate reduction for USB3.2 and DP2.1 can be implemented for the respective protocol lanes to achieve power and latency reduction, as outlined above with respect to USB3.2 and DP 2.1 devices. In MFD mode, an additional approach to reduce enumeration time and power (in the pre-OS boot phase and in the OS) is proposed. The proposal involves an improvement in the connect sequence shown in FIG. 11. FIGS. 10 and 11 show the MFD lane configuration by FLIP or orientation status, with FIG. 10 showing a schematic diagram of the MFD host and device setup, and FIG. 11 showing an MFD Alt Mode enter sequence.

Prior to entering the respective lane pair to any Alternate Mode (i.e., non USB3.2 mode), such as USB4, Thunderbolt 3, Thunderbolt 4, DP 2.1 or MFD, the host Super-Speed lanes may be configured in safe mode as shown in FIG. 11. In FIG. 11, initially, the Downstream Facing Port (DFP, the initiator) is in USB mode and the Upstream Facing Port (UFP, the responder) is in USB or USB safe state mode. When the DFP initiates a new mode, it sends an Enter Mode command to the UFP, which sends a GoodCRC, enters the new mode, and then sends an Acknowledgement (ACK). The DFP then switches to the new mode and sends a GoodCRC to the UFP.

In the MFD device, since one lane is always USB3.2, only the DP 2.1 lane is configured in safe mode. The USB can stay enumerated at the first connect while the non-USB DP 2.1 lane can be switched to safe mode before entering to Display mode. Thus, from the start of the sequence diagram shown in FIG. 11, the USB lane is not switched to safe mode (i.e., no new mode is necessary) thus not creating any disruption in the USB enumeration which enhances user experience. Power consumption and latency for the MFD enumeration is also reduced since only the DP2.1 lanes are switched to safe state.

In some examples, the FLIP or orientation information that is detected at connect by the host platform PD controller while negotiating with the device PD controller with CC lines is used. This is shown in FIG. 10 by the dotted lines 1010 between CC1 and CC2 of the host (on the left) and the device (on the right), respectively. In various implementations, the FLIP status is already communicated to the SoC (as shown by dotted line 1020). In various examples, the SoC may use the FLIP information to differentiate and decide between USB3.2 and DP2.1 lanes as shown in FIG. 10 (i.e., to decide whether Lane 0 or Lane 1 are USB3.2 or DP2.1 lanes, respectively) and accordingly apply the safe state to the DP 2.1 lane only. In other words, with respect to the method of FIG. 1a, in case the link is a multi-functional link comprising a data link and a graphics link, the method may comprise obtaining 110 orientation information (i.e., the FLIP information) regarding an orientation of a cable inserted into the multi-purpose communication port from a power delivery controller associated with the multi-purpose communication port. The safe state application to the SoC is then based on proposal 2, which relies on the Rx.Detect. Only one lane in the MFD may complete the Rx. Detect. The SoC may thus know on which lane the Rx.Detect should be performed based on the FLIP bit from the PD as proposed since the other lane is DP2.1 I/O. The method of FIG. 1a may thus comprise identifying 115 a lane for which the receive termination detect failure indication is obtained based on the orientation information. This concept is applicable in boot-pre-OS and in OS phases which reduces enumeration time, power and enhances user experience.

More details and aspects of the link optimization methods for (USB) Type C protocols to reduce system boot time and power are mentioned in connection with the proposed concept or one or more examples described above or below (e.g., FIG. 1a to 1b). The link optimization methods for (USB) Type C protocols to reduce system boot time and power may comprise one or more additional optional features corresponding to one or more aspects of the proposed concept or one or more examples described above or below.

In the following, some examples of the proposed concept are presented:

An example (e.g., example 1) relates to a method for bringing up a multi-purpose communication port, the method comprising determining (130), during a (pre-operating system) boot phase, a link type of a link to be established via the multi-purpose communication port, and performing (150), during the (pre-operating system) boot phase, link training on the multi-purpose communication port according to the link type, wherein, in case the link supports a first higher link rate or a first higher number of lanes, a second lower link rate or second lower number of lanes is used for link training on the multi-purpose communication port.

Another example (e.g., example 1) relates to a previous example (e.g., example 1) or to any other example, further comprising that the boot phase is a pre-operating system boot phase.

Another example (e.g., example 2) relates to a previous example (e.g., example 1 or 1a) or to any other example, further comprising that the multi-purpose communication port is an Universal Serial Bus type C, USB-C, port.

Another example (e.g., example 3) relates to a previous example (e.g., one of the examples 1, 1a or 2) or to any other example, further comprising that the method further comprises performing (170), during an operating system boot phase, second link training, wherein, in case the link supports the first higher link rate or the first higher number of lanes, the first higher link rate or the first higher number of lanes is used for link training on the multi-purpose communication port.

Another example (e.g., example 4) relates to a previous example (e.g., one of the examples 1 to 3) or to any other example, further comprising that the method comprises, during the (pre-operating system) boot phase, in case the link supports a first higher link rate or a first higher number of lanes, overwriting (140) one or more parameter values specifying the link rate and/or number of lanes of the communication link prior to performing the link training at the lower rate and lower number of lanes, and wherein the one or more parameter values are automatically restored (160) in an operating system boot phase after having performed the link functions during the (pre-operating system) boot phase.

Another example (e.g., example 5) relates to a previous example (e.g., one of the examples 1 to 4) or to any other example, further comprising that operations performed during the (pre-operating system) boot phase are performed by a system firmware of a computer system comprising the multi-purpose communication port.

Another example (e.g., example 6) relates to a previous example (e.g., one of the examples 1 to 5) or to any other example, further comprising that the link type is one of data link, graphics link and multi-functional link.

Another example (e.g., example 7) relates to a previous example (e.g., one of the examples 1 to 6) or to any other example, further comprising that during the (pre-operating system) boot/training phase, the link training is performed with a minimal number of lanes and/or with a minimal link rate supported by the respective link.

Another example (e.g., example 8) relates to a previous example (e.g., one of the examples 1 to 7) or to any other example, further comprising that in case the link is a data link according to the Universal Serial Bus 4 protocol, link training is performed with a single lane at 10 Gbps link rate.

Another example (e.g., example 9) relates to a previous example (e.g., one of the examples 1 to 8) or to any other example, further comprising that in case the link is a data link according to the Universal Serial Bus 3.2 protocol, link training is performed with a single lane at 5 Gbps link rate.

Another example (e.g., example 10) relates to a previous example (e.g., one of the examples 1 to 9) or to any other example, further comprising that in case the link is a graphics link, link training is performed with a minimal lane width and/or minimal link rate supported by a display connected to the multi-purpose communication port.

Another example (e.g., example 11) relates to a previous example (e.g., one of the examples 1 to 10) or to any other example, further comprising that in case the link is a multi-functional link comprising a data link and a graphics link, link training is performed with a respective minimal link rate supported by the protocol used for the data link and with a minimal link rate supported by a display connected to the graphics link.

Another example (e.g., example 12) relates to a previous example (e.g., one of the examples 1 to 11) or to any other example, further comprising that the method comprises, in case the multi-purpose communication port supports communication according to a first protocol and according to a second protocol, with a first controller being used for communicating according to the first protocol and a second controller being used to communicate according to the second protocol, obtaining (120), during the (pre-operating system) boot phase, a receive termination detect failure indication from the first controller, and instructing (125) the first controller to enter a safe state based on the receive termination detect failure indication obtained from the first controller.

Another example (e.g., example 13) relates to a previous example (e.g., example 12) or to any other example, further comprising that the first controller is instructed to enter the safe state without waiting for a trigger for entering the safe state being provided by a power delivery controller associated with the multi-purpose communication port.

Another example (e.g., example 14) relates to a previous example (e.g., one of the examples 12 or 13) or to any other example, further comprising that in case the link is a multi-functional link comprising a data link and a graphics link, the method comprises obtaining (110) orientation information regarding an orientation of a cable inserted into the multi-purpose communication port from a power delivery controller associated with the multi-purpose communication port, and identifying (115) a lane for which the receive termination detect failure indication is obtained based on the orientation information.

Another example (e.g., example 15) relates to a previous example (e.g., one of the examples 12 to 14) or to any other example, further comprising that the first protocol is a first lower Universal Serial Bus, USB, protocol, and wherein the second protocol is a second higher USB protocol, such as USB4 or Thunderbolt 4, or a Display Port, DP, protocol.

An example (e.g., example 16) relates to an apparatus (10) for bringing up a multi-purpose communication port (105), the apparatus comprising interface circuitry (12), machine-readable instructions, and processor circuitry (14) to execute the machine-readable instructions to determine, during a (pre-operating system) boot phase, a link type of a link to be established via the multi-purpose communication port, and perform, during the (pre-operating system) boot phase, link training on the multi-purpose communication port according to the link type, wherein, in case the link supports a first higher link rate or a first higher number of lanes, a second lower link rate or second lower number of lanes is used for link training on the multi-purpose communication port.

An example (e.g., example 17) relates to an apparatus (10) for bringing up a multi-purpose communication port (105), the apparatus comprising processor circuitry (14) configured to determine, during a (pre-operating system) boot phase, a link type of a link to be established via the multi-purpose communication port, and perform, during the (pre-operating system) boot phase, link training on the multi-purpose communication port according to the link type, wherein, in case the link supports a first higher link rate or a first higher number of lanes, a second lower link rate or second lower number of lanes is used for link training on the multi-purpose communication port.

An example (e.g., example 18) relates to a device (10) for bringing up a multi-purpose communication port (105), the device comprising means for processing (14) for determining, during a (pre-operating system) boot phase, a link type of a link to be established via the multi-purpose communication port, and performing, during the (pre-operating system) boot phase, link training on the multi-purpose communication port according to the link type, wherein, in case the link supports a first higher link rate or a first higher number of lanes, a second lower link rate or second lower number of lanes is used for link training on the multi-purpose communication port.

Another example (e.g., example 19) relates to a computer system (100) comprising the apparatus (10) or device (10) according to one of the examples 16 to 18 (or according to any other example) and the multi-purpose communication port (105)

Another example (e.g., example 20) relates to a computer system (100) to perform the method according to one of the examples 1 to 15 (or according to any other example), the computer system comprising the multi-purpose communication port (105).

Another example (e.g., example 21) relates to a non-transitory, computer-readable medium comprising a program code that, when the program code is executed on a processor, a computer, or a programmable hardware component, causes the processor, computer, or programmable hardware component to perform the method of one of the examples 1 to 15 (or according to any other example).

Another example (e.g., example 22) relates to a non-transitory machine-readable storage medium including program code, when executed, to cause a machine to perform the method of one of the examples 1 to 15 (or according to any other example).

Another example (e.g., example 23) relates to a computer program having a program code for performing the method of one of the examples 1 to 15 (or according to any other example) when the computer program is executed on a computer, a processor, or a programmable hardware component.

Another examples (e.g., example 24) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for a multi-purpose communication port, the apparatus comprising interface circuitry, machine-readable instructions, and processor circuitry to execute the machine-readable instructions to:
determine, during a boot phase, a link type of a link to be established via the multi-purpose communication port; and
perform, during the boot phase, link training on the multi-purpose communication port according to the link type, wherein, in case the link supports a first higher link rate or a first higher number of lanes, a second lower link rate or second lower number of lanes is used for link training the multi-purpose communication port.

2. The apparatus according to claim 1, wherein the boot phase is a pre-operating system boot phase.

3. The apparatus according to claim 1, wherein the multi-purpose communication port is an Universal Serial Bus type C (USB-C) port.

4. The apparatus according to claim 1, wherein the processor circuitry is to execute the machine-readable instructions to perform, during an operating system boot phase, second link training, wherein, in case the link supports the first higher link rate or the first higher number of lanes, the first higher link rate or the first higher number of lanes is used for link training on the multi-purpose communication port.

5. The apparatus according to claim 1, wherein the processor circuitry is to execute the machine-readable instructions to, during the boot phase, in case the link supports a first higher link rate or a first higher number of lanes, overwrite one or more parameter values specifying the link rate and/or number of lanes of the communication link prior to performing the link training at the lower rate and lower number of lanes, and wherein the one or more parameter values are automatically restored in an operating system boot phase after having performed the link functions during the boot phase.

6. The apparatus according to claim 1, wherein operations performed during the boot phase are performed by a system firmware of a computer system comprising the multi-purpose communication port.

7. The apparatus according to claim 1, wherein the link type is one of data link, graphics link and multi-functional link.

8. The apparatus according to claim 1, wherein, during the boot phase, the link training is performed with a minimal number of lanes and/or with a minimal link rate supported by the respective link.

9. The apparatus according to claim 1, wherein, in case the link is a data link according to the Universal Serial Bus 4 protocol, link training is performed with a single lane at 10 Gbps link rate.

10. The apparatus according to claim 1, wherein, in case the link is a data link according to the Universal Serial Bus 3.2 protocol, link training is performed with a single lane at 5 Gbps link rate.

11. The apparatus according to claim 1, wherein, in case the link is a graphics link, link training is performed with a minimal lane width and/or minimal link rate supported by a display connected to the multi-purpose communication port.

12. The apparatus according to claim 1, wherein, in case the link is a multi-functional link comprising a data link and a graphics link, link training is performed with a respective minimal link rate supported by the protocol used for the data link and with a minimal link rate supported by a display connected to the graphics link.

13. The apparatus according to claim 1, wherein the processor circuitry is to execute the machine-readable instructions to, in case the multi-purpose communication port supports communication according to a first protocol and according to a second protocol, with a first controller being used for communicating according to the first protocol and a second controller being used to communicate according to the second protocol, obtain, during the boot phase, a receive termination detect failure indication from the first controller, and instruct the first controller to enter a safe state based on the receive termination detect failure indication obtained from the first controller.

14. The apparatus according to claim 13, wherein the first controller is instructed to enter the safe state without waiting for a trigger for entering the safe state being provided by a power delivery controller associated with the multi-purpose communication port.

15. The apparatus according to claim 13, wherein, in case the link is a multi-functional link comprising a data link and a graphics link, the processor circuitry is to execute the machine-readable instructions to obtain orientation information regarding an orientation of a cable inserted into the multi-purpose communication port from a power delivery controller associated with the multi-purpose communication port, and identify a lane for which the receive termination detect failure indication is obtained based on the orientation information.

16. The apparatus according to claim 13, wherein the first protocol is a first lower Universal Serial Bus (USB) protocol, and wherein the second protocol is a second higher USB protocol, such as USB4 or Thunderbolt 4, or a Display Port (DP) protocol.

17. A computer system comprising the apparatus according to claim 1 and the multi-purpose communication port.

18. A method for bringing up a multi-purpose communication port, the method comprising:
determining, during a boot phase, a link type of a link to be established via the multi-purpose communication port; and
performing, during the boot phase, link training on the multi-purpose communication port according to the link type, wherein, in case the link supports a first higher link rate or a first higher number of lanes, a second lower link rate or second lower number of lanes is used for link training on the multi-purpose communication port.

19. A non-transitory, computer-readable medium comprising a program code that, when the program code is executed on a processor, a computer, or a programmable hardware component, causes the processor, computer, or programmable hardware component to perform the method of claim 18.
